(19) United States
(12) Patent Application Publication
(10) Pub. No.: US 2026/0238638 A1
(43) Pub. Date: Aug. 13, 2026

(54) SYSTEM USING DYNAMIC SALIENCY FOR TOKEN EXPIRATION MESSAGES

(71) Applicant: Toshiba Tec Kabushiki Kaisha, Tokyo (JP)

(72) Inventors: Marianne KODIMER, Huntington Beach, CA (US); Matthew CHAN, Irvine, CA (US)

(21) Appl. No.: 19/050,999

(22) Filed: Feb. 11, 2025

(51) Int. Cl. H04L 9/40

(52) U.S. Cl. CPC H04L 63/0846

(57) ABSTRACT

A management computer is configured to manage authentication tokens, by performing the steps of: determining that a first authentication token has reached a first time marker; transmitting, to a user computer associated with the first authentication token in response to reaching the first time marker, a first alert indicating that the first authentication token is set to expire; determining, after transmitting the first alert, that the first authentication token has reached a second time marker; transmitting, to the user computer in response to reaching the second time marker, a second alert indicating that the first authentication token is set to expire, a property in the second alert being changed from that in the first alert; and generating a second authentication token in response to a request to generate a new authentication token, to replace the first authentication token, and then persisting the second authentication token in a database.

### FIELD

Embodiments to be described herein generally relate to a management computer configured to carry out steps for managing authentication tokens, a method comprising such steps, and a non-transitory computer-readable medium comprising instructions that cause a management computer to carry out such steps.

### BACKGROUND

Authentication tokens are pieces of data used widely by software systems to confirm the identity of users and grant access to protected resources. For example, possession of an authentication token may act as a factor for confirming a user's identity when the user makes an application programming interface (API) request. Common examples of authentication tokens include JavaScript Object Notation (JSON) web tokens (JWTs), open authorization (OAuth) tokens, session tokens, API keys, and bearer tokens. Authentication tokens often have expiration dates for enhancing security, e.g., such dates limiting a window of use for an authentication token that has been intercepted or compromised. A user may thus periodically generate a new authentication token or request a software system to automatically generate a new authentication token to maintain access to protected resources. There is desire to implement a system that mitigates the risk of authentication tokens expiring before new authentication tokens are generated in their place.

### BRIEF DESCRIPTION OF THE DRAWINGS

FIG. 1 is a block diagram of a computer system in which embodiments may be implemented.

FIGS. 2A-2E are a sequence of block diagrams illustrating a user interface (UI) for alerting a user to generate an authentication token.

FIG. 3 is a flow diagram of a method that may be performed by a management computer of the computer system to alert a user computer of the computer system about the expiration of an authentication token, according to some embodiments.

FIG. 4 is a flow diagram of a method that may be performed by a third-party computer of the computer system and the management computer to generate a new authentication token and use the new authentication token to process an API request, according to some embodiments.

FIG. 5 is a flow diagram of a method that may be performed by the user computer and the management computer to generate a new authentication token and use the new authentication token to process an API request, according to some embodiments.

### DETAILED DESCRIPTION

One or more embodiments provide a management computer including a processor and memory, wherein the processor executes instructions stored in the memory to manage authentication tokens. The management computer performs the steps of: determining that a first authentication token for using a software service has reached a first time marker, the first time marker indicating that the first authentication token will expire in a first predetermined amount of time; transmitting, to a user computer associated with the first authentication token in response to reaching the first time marker, a first alert indicating that the first authentication token is set to expire; determining, after transmitting the first alert, that the first authentication token has reached a second time marker, the second time marker indicating that the first authentication token will expire in a second predetermined amount of time that is less than the first predetermined amount of time; transmitting, to the user computer in response to reaching the second time marker, a second alert indicating that the first authentication token is set to expire, a property in the second alert being changed from that in the first alert; and generating a second authentication token in response to a request to generate a new authentication token, to replace the first authentication token, and then persisting the second authentication token in a database of the management computer.

According to embodiments, the management computer dynamically adjusts a saliency of alerts provided to the user computer regarding the expiration of an authentication token. Such authentication token may be used, e.g., by the user computer or by a third-party computer for authenticating with the management computer when making API calls and using a software service of the management computer. For example, an alert may be sent to the user computer one month before the authentication token expires. Then, until a new authentication token is generated, subsequent alerts may be sent to the user computer, e.g., weekly until the authentication token is one week away from expiring, and then daily during the last week.

Over time, the management computer adjusts the saliency of such alerts, e.g., by adjusting properties of the alerts such as font properties and by adjusting transmission mechanisms for the alerts. Accordingly, the management computer causes later alerts to be more salient than earlier alerts, which increases the likelihood of a user generating a new authentication token before an authentication token expires. Hereinafter, embodiments will be described with reference to the drawings. In the drawings, the same reference symbols denote the same or similar portions.

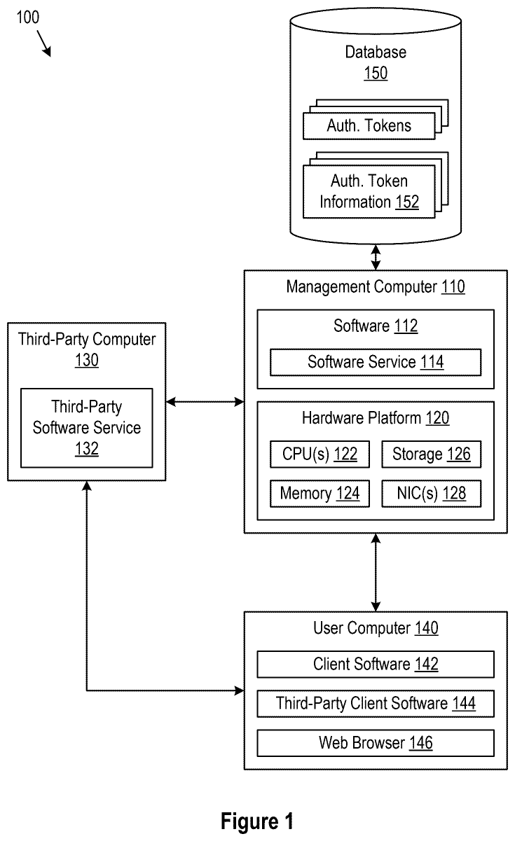

FIG. 1 is a block diagram of a computer system 100 in which embodiments may be implemented. Computer system 100 includes a management computer 110, a third-party computer 130, and a user computer 140. Management computer 110 manages authentication tokens, which are stored in a database 150. Management computer 110 may also provide copies of some of the authentication tokens to third-party computer 130 and additional copies or copies of other authentication tokens, to user computer 140. Third-party computer 130 and user computer 140 may then use respective authentication tokens for authenticating with management computer 110 and using a software service 114 thereon, e.g., when making API calls.

Management computer 110 may be, e.g. a server computer. For example, management computer 110 may be deployed in a private data center or a public data center. Management computer 110 is constructed on a hardware platform 120 such as an x86 architecture platform. Hardware platform 120 includes components of a computer, such as one or more central processing units (CPUs) 122, memory 124 such as random-access memory (RAM), local storage 126 such as one or more magnetic drives or solid-state drives (SSDs), and one or more network interface controllers (NICs) 128. CPU(s) 122 are configured to execute instructions such as executable instructions that perform one or more operations described herein, which may be stored in memory 124. Computer 110 may communicate with other devices, including third-party computer 130 and user computer 140, over a network such as the Internet.

Hardware platform 120 supports software 112, including a software service 114. Software service 114 is a software application or solution made remotely available to third-party computer 130 and to a user of user computer 140. For example, software service 114 may be a solution that supports cloud-based printing such as e-BRIDGE® Global Print, available from Toshiba Tec Corp.

For authentication, software service 114 may generate authentication tokens and persist them in database 150. Software service 114 may further generate associated authentication token information 152 and persist it in database 150. For example, authentication token information 152 may include alert schedules for sending alerts about expirations of respective authentication tokens. Database 150 is a structured collection of data that is managed by software service 114. For example, database 150 may be stored externally from management computer 110, e.g., on one or more magnetic drives or SSDs of a storage array. As another example, although illustrated as being external to management computer 110, database 150 may be stored in storage 126 of hardware platform 120.

Third-party computer 130 is a computer such as a server computer that is used by a third-party software provider that interfaces with management computer 110. For example, third-party computer 130 may be deployed in a private data center or a public data center separate from that of management computer 110. User computer 140 is a computer used by a user of software service 114, such as a desktop computer, laptop computer, or smartphone. For example, user computer 140 may be deployed in a user's home or workplace.

Similar to hardware platform 120, third-party computer 130 and user computer 140 each includes a hardware platform (not shown) including components of a computer, such as one or more CPUs, memory such as RAM, and one or more NICs. The CPUs are configured to execute instructions such as executable instructions that perform one or more operations described herein, which may be stored in the memory of respective ones of third-party computer 130 and user computer 140. Third-party computer 130 and user computer 140 may communicate with other devices, including each other and management computer 110, over a network such as the Internet.

Third-party computer 130 includes a third-party software service 132. Third-party software service 132 is a software application or solution that uses software service 114 and that may be made remotely available to the user of user computer 140. For example, third-party software service 132 may be a data visualization tool that generates charts and reports based on usage data of software service 114, such as Tableau, ® available from Salesforce, Inc.

User computer 140 includes client software 142, third-party client software 144, and web browser 146. Client software 142 is software such as a client-side application corresponding to software service 114, and third-party client software 144 is software such as a client-side application corresponding to third-party software service 132. For example, client software 142 may display a user interface (UI) of software service 114, and third-party client software 144 may display a UI of third-party software service 132. Web browser 146 is a software application used for accessing and viewing content on the Internet. According to some embodiments, the user may access software service 114 using web browser 146 to navigate to a uniform resource locator (URL) of software service 114. Similarly, according to some embodiments, the user may access third-party software service 132 using web browser 146 to navigate to a URL of third-party software service 132.

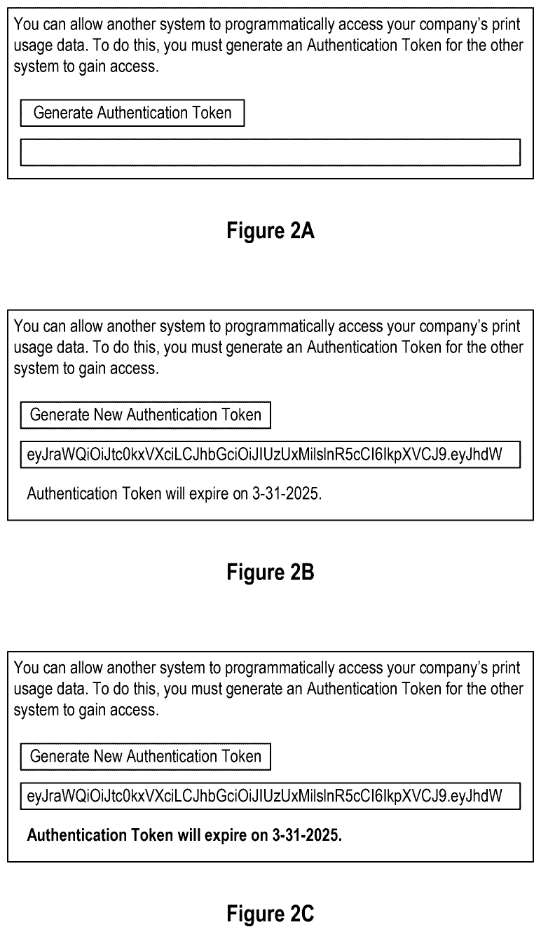

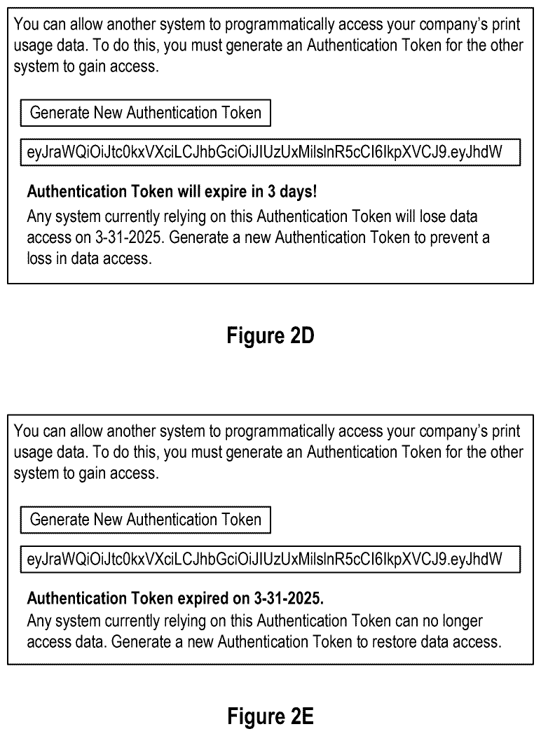

FIGS. 2A-2E are a sequence of block diagrams illustrating a UI of software service 114 for alerting the user of user computer 140 to generate an authentication token. For example, the user may view the alert on client software 142 or web browser 146. In the example of FIGS. 2A-2E, the authentication token to be generated is an authentication token to be used by third-party software service 132 to authenticate with software service 114. However, similar alerts may be sent to user computer 140 for prompting the user to generate an authentication token for user computer 140 to authenticate with software service 114.

FIG. 2A is an example of a preliminary alert that software service 114 may send to user computer 140 to generate a first authentication token. For example, management computer 110 may send the alert for setting up authentication privileges for third-party software service 132 or user computer 140. In the example of FIG. 2A, the alert includes a message indicating that another system, e.g., third-party software service 132, seeks to access print usage data, e.g., stored by or accessible to software service 114. The alert further prompts the user of user computer 140 to generate an authentication token for the other system. The user may click the “Generate Authentication Token” button to generate the authentication token.

FIG. 2B is an example of an alert after an authentication token has been generated. For example, the alert of FIG. 2B may be sent to user computer 140 one month before the generated authentication token is set to expire. For example, the authentication token may have been generated by software service 114 in response to the user clicking the “Generate Authentication Token” button of FIG. 2A. Software service 114 may have further determined an expiration date, e.g., of “3-31-2025,” which software service 114 may have embedded in the authentication token. As illustrated in FIG. 2B, software service 114 may include the generated authentication token in the alert for the user to view. Further, in the alert, software service 114 may display a message indicating the expiration date and may prompt the user to generate a new authentication token using a new “Generate New Authentication Token” button.

FIG. 2C is an example of another alert after the alert of FIG. 2B. For example, the alert of FIG. 2C may be sent to user computer 140 one week before the authentication token is set to expire. In the example of FIG. 2C, a font property is changed from the alert of FIG. 2B. Specifically, the warning about the expiration of authentication token is made bold to make the alert more salient than the previous alert. Additional or alternative font property changes (not shown) may include, e.g., highlighting the warning about the expiration or changing its color, e.g., from black to a more salient color such as red.

FIG. 2D is an example of another alert after the alert of FIG. 2C. For example, the alert of FIG. 2D may be sent to user computer 140 3 days before the authentication token is set to expire. In the example of FIG. 2D, a messaging property is changed from the alert of FIG. 2C. Specifically, software service 114 added additional warning messages to make the alert more salient than the previous alert. Such messages include an exclamatory statement about the authentication token expiring in 3 days. Such messages further include an additional warning that any systems, e.g., third-party software service 132, are set to “lose data access.” Additionally, for example, a font property may be applied such as highlighting the exclamatory statement or setting the color thereof, e.g., to red (not shown).

FIG. 2E is an example of another alert after the alert of FIG. 2D, specifically after the authentication token has expired. In the example of FIG. 2E, a messaging property is changed from the alert of FIG. 2D. Specifically, software service 114 added a message indicating that the authentication token has expired and that any system, e.g., third-party software service 132, has lost data access. Additionally, for example, a font property may be applied such as highlighting the message about the authentication token expiring or setting the color thereof, e.g., to red (not shown).

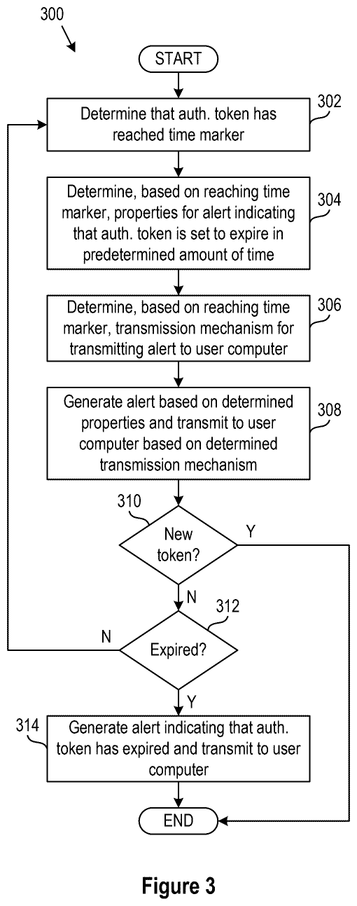

FIG. 3 is a flow diagram of a method 300 that may be performed by management computer 110 to alert user computer 140 about the expiration of an authentication token, according to some embodiments. At step 302, software service 114 determines that an authentication token has reached a time marker. As used herein, a “time marker” is a time for sending an alert to user computer 140 that an authentication token is set to expire, and a time marker is associated with a predetermined amount of time before such expiration, e.g., 1 month before, 1 week before, 3 days before, etc. For example, software service 114 may store such time markers in authentication token information 152 for each authentication token, as part of each token's alert schedule. Software service 114 may then determine that an authentication token has reached a time marker by checking database 150.

At step 304, software service 114 determines, based on reaching the time marker, properties for an alert indicating that the authentication token is set to expire. For example, the properties may include a font property. For example, if the time marker is early, e.g., 1 month before expiration, text in the alert may be plain, e.g., black, not bold, not italicized, not underlined, and not highlighted. If the time marker is later, e.g., 3 days before expiration, the alert may include, e.g., bold text, italicized text, underlined text, highlighted text, or colored (e.g., red) text. The bold, italicized, underlined, highlighted, or colored text may be text that corresponds to text of an earlier alert or may be added text. As another example, if the time marker is later, e.g., 3 days before expiration, the alert may include larger text than text of an earlier alert, e.g., larger than corresponding text of an earlier alert.

As another example, the properties may include a messaging property. For example, if the time marker is early, the text may include a message merely indicating that the authentication token is set to expire on a predetermined date. If the time marker is later, the alert may include an additional warning message about consequences of the authentication token expiring, e.g., third-party software service 132 or user computer 140 losing access to protected data. As another example, the properties may include an audio property. For example, if the time marker is early, the alert may be silent. If the time marker is later, the alert may include a warning sound such as a short, sharp tone designed to be salient.

At step 306, software service 114 may determine, based on reaching the time marker, a transmission mechanism for transmitting the alert to user computer 140. As used herein, a “transmission mechanism” is a method or system of transferring data between computers or networks. For example, if the time marker is early, software service 114 may determine to send the alert as a UI message to client software 142 or web browser 146 or to send an email to an email address associated with the user of user computer 140. As another example, if the time marker is later, software service 114 may determine to send the alert as a push notification to a push notification service associated with user computer 140, which may route the alert to client software 142 or web browser 146 as a push notification. As another example, if the time marker is later, software service 114 may determine to send the alert as a text message to a phone number associated with the user.

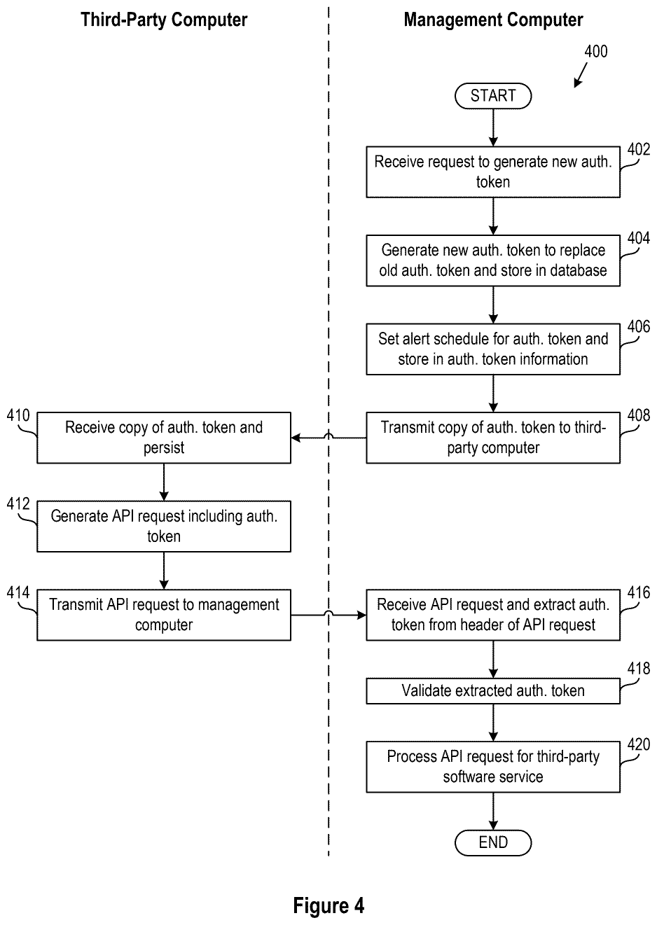

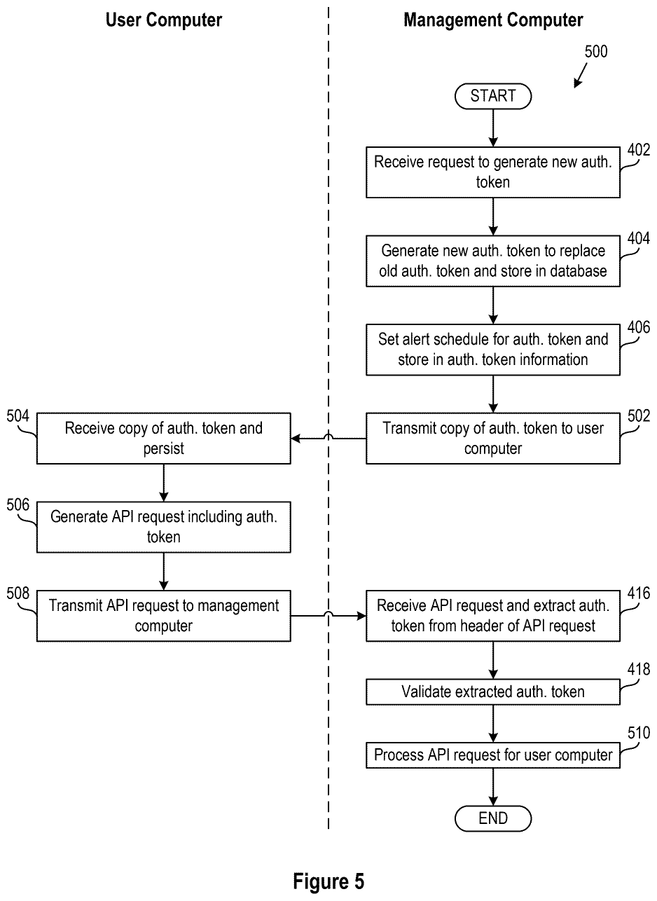

At step 308, software service 114 generates the alert based on the determined properties, and management computer 110 transmits the alert to user computer 140. Management computer 110 may transmit the alert based on the determined transmission mechanism. At step 310, if a new authentication token has been generated, method 300 ends. Examples of generating an authentication token are discussed below in conjunction with FIGS. 4 and 5. Returning to step 310, if a new authentication token has not yet been generated, method 300 moves to step 312.

At step 312, if the authentication token has not yet expired by the time it reaches a new time marker, method 300 returns to step 302, and steps 302-310 are repeated based on the new time marker. As discussed above, based on the new time marker, software service 114 may determine updated properties for alerting user computer 140 such as updated text properties, messaging properties, or audio properties. Additionally, as discussed above, based on the next time marker, software service 114 may determine a different transmission mechanism for alerting user computer 140 such as transmitting a push notification or text message.

Returning to step 312, if the authentication token expires before a new authentication token is generated, method 300 moves to step 314. At step 314, software service 114 generates an alert indicating that the authentication token has expired, and management computer 110 transmits the alert to user computer 140. Software service 114 may generate the alert to include salient properties discussed above, such as for font properties, messaging properties, or audio properties. Management computer 110 may further transmit the alert based on a determined mechanism such as a push notification or text message. After step 314, method 300 ends.

FIG. 4 is a flow diagram of a method 400 that may be performed by third-party computer 130 and management computer 110 to generate a new authentication token and use the new authentication token to process an API request, according to some embodiments. At step 402, management computer 110 receives a request to generate a new authentication token. For example, the user of user computer 140 may trigger the request, e.g., using client software 142 or web browser 146, and user computer 140 may transmit the request to management computer 110.

At step 404, software service 114 generates a new authentication token to replace an old authentication token. Management computer 110 further stores the new authentication token in database 150. At step 406, software service 114 sets an alert schedule for the new authentication token, and management computer 110 stores the alert schedule in authentication token information 152 in database 150. For example, software service 114 may set time markers for alerting about the authentication token expiring. For example, software service 114 may set such time markers to increase in frequency over time, e.g., being weekly starting when the authentication token is 1 month from expiring, and becoming daily when the authentication token is 1 week away from expiring.

At step 408, management computer 110 transmits a copy of the authentication token to third-party computer 130. At step 410, third-party computer 130 receives the authentication token and persists the authentication token in storage thereof. At step 412, third-party software service 132 generates an API request for software service 114. For example, the API request may request software service 114 to execute an operation or retrieve protected data. Third-party software service 132 includes the authentication token with the API request, e.g., in a header in the API request.

At step 414, third-party computer 130 transmits the API request to management computer 110. At step 416, management computer 110 receives the API request, and software service 114 extracts the authentication token, e.g., from a header in the API request. At step 418, software service 114 validates the extracted authentication token. For example, software service 114 may check database 150 to determine that the extracted authentication token corresponds to (e.g., matches) an authentication token stored in database 150. For example, software service 114 may further check authentication token information 152 to determine, based on a schedule therein, that the extracted authentication token has not expired. As another example, software service 114 may check privileges associated with the extracted authentication token, which may be stored in authentication token information 152, to determine that the authentication token authorizes a holder thereof, e.g., to execute the requested operation or access the requested data.

At step 420, in response to successfully validating the extracted authentication token, management computer 110 processes the API request for third-party software service 132. For example, software service 114 may execute the requested operation or retrieve the requested data, e.g., from storage 126 or from another device on which the data is stored, e.g., another computer or a printing device such as a multi-function printer (MFP). Software service 114 may then generate a response to the API request, including, e.g., a result of executing the operation or the requested data. Management computer 110 may then transmit the response to third-party computer 130. After step 420, method 400 ends, and third-party software service 132 may use information from the response. For example, if the response includes usage data of a device such as an MFP, third-party software service 132 may perform operations using the usage data, e.g., generating a chart or report, and third-party computer 130 may send the chart or report to user computer 140.

FIG. 5 is a flow diagram of a method 500 that may be performed by user computer 140 and management computer 110 to generate a new authentication token and use the new authentication token to process an API request, according to some embodiments. Steps that are similar to or the same as corresponding steps of method 400 include the same reference numbers and will not be explained again. After generating a new authentication token and alert schedule and storing the authentication token and alert schedule in database 150, at step 502, management computer 110 transmits a copy of the authentication token to user computer 140.

At step 504, user computer 140 receives the authentication token and persists the authentication token in storage thereof. At step 506, user computer 140 generates an API request for software service 114. For example, the API request may request software service 114 to execute an operation or retrieve protected data. User computer 140 includes the authentication token with the API request, e.g., in a header in the API request.

At step 508, user computer 140 transmits the API request to management computer 110. After software service 114 extracts the authentication token from the API request and in response to validating the extracted authentication token, at step 510, management computer 110 processes the API request for user computer 140. For example, software service 114 may execute the requested operation or retrieve the requested data, e.g., from storage 126 or from another device on which the data is stored. Software service 114 may then generate a response to the API request, including, e.g., a result of executing the operation or the requested data. Management computer 110 may then transmit the response to user computer 140. After step 510, method 500 ends, and user computer 140 may use information from the response.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

The embodiments described herein also relate to an apparatus for performing these operations. The apparatus may be specially constructed for required purposes, or the apparatus may be a general-purpose computer selectively activated or configured by a computer program stored in the computer. The embodiments described herein may also be practiced with computer system configurations including mobile computing devices, personal computers, server computers, microprocessor systems, mainframe computers, etc., and combinations thereof, which may communicate across one or more networks.

The embodiments described herein also relate to one or more computer programs or as one or more computer program modules embodied in computer-readable storage media. The term computer-readable medium refers to any data storage device that can store data, which can thereafter be input into an apparatus or computer system. Computer-readable media may be based on any existing or subsequently developed technology that embodies computer programs in a manner that enables a computer to read the programs. Examples of computer-readable media include magnetic drives, SSDs, network-attached storage (NAS) systems, RAM, read-only memory (ROM), compact disks (CDs), digital versatile disks (DVDs), and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

As used herein, the phrase “at least one of” preceding a series of items with the term “and” or “or” to separate any of the items, modifies the list as a whole, rather than each member of the list (i.e., each item). The phrase “at least one of” does not require selection of at least one of each item listed. Rather, the phrase allows a meaning that includes at least one of any one of the items, and/or at least one of any combination of the items. By way of example, the phrases “at least one of A, B, and C” and “at least one of A, B, or C” each refers to only A, only B, only C, and/or any combination of A, B, and C. In any instances in which it is intended that a selection be of “at least one of each of A, B, and C,” or alternatively, “at least one of A, at least one of B, and at least one of C,” the selection is expressly described as such.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components may be implemented as a combined component. Similarly, structures and functionalities presented as a single component may be implemented as separate components. These and other variations, additions, and improvements may fall within the scope of the appended claims.

What is claimed is:

1. A management computer including a processor and memory, wherein the processor executes instructions stored in the memory to manage authentication tokens by performing the following steps:
determining that a first authentication token for using a software service has reached a first time marker, the first time marker indicating that the first authentication token will expire in a first predetermined amount of time;
transmitting, to a user computer associated with the first authentication token in response to reaching the first time marker, a first alert indicating that the first authentication token is set to expire;
determining, after transmitting the first alert, that the first authentication token has reached a second time marker, the second time marker indicating that the first authentication token will expire in a second predetermined amount of time that is less than the first predetermined amount of time;
transmitting, to the user computer in response to reaching the second time marker, a second alert indicating that the first authentication token is set to expire, a property in the second alert being changed from that in the first alert; and
generating a second authentication token in response to a request to generate a new authentication token, to replace the first authentication token, and then persisting the second authentication token in a database of the management computer.

2. The management computer of claim 1, wherein the property is a font property, and the steps further include:
generating the second alert to include add at least one of: bold text that is not bold in the first alert, italicized text that is not italicized in the first alert, underlined text that is not underlined in the first alert, highlighted text that is not highlighted in the first alert, text that is a different color than corresponding text in the first alert, and text that is larger than text of the first alert.

3. The management computer of claim 1, wherein the property is a messaging property, and the steps further include:
generating, in response to reaching the second time marker, the second alert to include a warning message that the first alert does not include.

4. The management computer of claim 1, wherein the property is an audio property, and the steps further include:
generating, in response to reaching the second time marker, the second alert to include a warning sound that the first alert does not include.

5. The management computer of claim 1, wherein the steps further include:
determining, after transmitting the second alert, that the first authentication token has reached a third time marker, the third time marker indicating that the first authentication token will expire in a third predetermined amount of time that is less than the second predetermined amount of time, a first time period from the first time marker to the second time marker being greater than a second time period from the second time marker to the third time marker; and
transmitting, to the user computer in response to reaching the third time marker, a third alert indicating that the first authentication token is set to expire.

6. The management computer of claim 1, wherein the steps further include:
determining, based on the first time marker, a first transmission mechanism for transmitting the first alert to the user computer;
determining, based on the second time marker, a second transmission mechanism for transmitting the second alert to the user computer, the second transmission mechanism being different from the first transmission mechanism, and the first and second transmission mechanisms each being one of: sending a user interface (UI) message to an application executing on the user computer, sending an email to an email address associated with a user of the user computer, sending a push notification to a push notification service associated with the user computer, and sending a text message to a phone number associated with the user; and
transmitting the first alert to the user computer using the first transmission mechanism, and transmitting the second alert to the user computer using the second transmission mechanism.

7. The management computer of claim 1, wherein the steps further include:
transmitting the second authentication token to a third-party server and then receiving an application programming interface (API) request from the third-party server;
extracting the second authentication token from a header of the API request, and validating the extracted second authentication token; and
processing the API request in response to validating the extracted second authentication token.

8. The management computer of claim 7, wherein processing the API request comprises:
executing a requested operation or retrieving requested data; and
transmitting a response to the third-party server based on executing the requested operation or based on retrieving the requested data.

9. The management computer of claim 1, wherein the steps further include:
transmitting the second authentication token to the user computer and then receiving an application programming interface (API) request from the user computer;
extracting the second authentication token from a header of the API request, and validating the extracted second authentication token; and
processing the API request in response to validating the extracted second authentication token.

10. The management computer of claim 9, wherein processing the API request comprises:
executing a requested operation or retrieving requested data; and
transmitting a response to the user computer based on executing the requested operation or based on retrieving the requested data.

11. A method of managing authentication tokens, the method comprising:
determining that a first authentication token for using a software service has reached a first time marker, wherein the first time marker indicates that the first authentication token will expire in a first predetermined amount of time;
transmitting, to a user computer associated with the first authentication token in response to reaching the first time marker, a first alert indicating that the first authentication token is set to expire;
determining, after transmitting the first alert, that the first authentication token has reached a second time marker, wherein the second time marker indicates that the first authentication token will expire in a second predetermined amount of time that is less than the first predetermined amount of time;
transmitting, to the user computer in response to reaching the second time marker, a second alert indicating that the first authentication token is set to expire, wherein a property in the second alert is changed from that in the first alert; and
generating a second authentication token in response to a request to generate a new authentication token, to replace the first authentication token, and then persisting the second authentication token in a database.

12. The method of claim 1, wherein the property is a font property, the method further comprising:
generating the second alert to include add at least one of: bold text that is not bold in the first alert, italicized text that is not italicized in the first alert, underlined text that is not underlined in the first alert, highlighted text that is not highlighted in the first alert, text that is a different color than corresponding text in the first alert, and text that is larger than text of the first alert.

13. The method of claim 1, wherein the property is a messaging property, the method further comprising:
generating, in response to reaching the second time marker, the second alert to include a warning message that the first alert does not include.

14. The method of claim 1, wherein the property is an audio property, the method further comprising:
generating, in response to reaching the second time marker, the second alert to include a warning sound that the first alert does not include.

15. The method of claim 1, further comprising:
determining, after transmitting the second alert, that the first authentication token has reached a third time marker, wherein the third time marker indicates that the first authentication token will expire in a third predetermined amount of time that is less than the second predetermined amount of time, and wherein a first time period from the first time marker to the second time marker is greater than a second time period from the second time marker to the third time marker; and
transmitting, to the user computer in response to reaching the third time marker, a third alert indicating that the first authentication token is set to expire.

16. A non-transitory, computer-readable medium comprising instructions that are executable in a management computer, wherein the instructions when executed cause the management computer to carry out a method of managing authentication tokens, and wherein the method comprises:
determining that a first authentication token for using a software service has reached a first time marker, the first time marker indicating that the first authentication token will expire in a first predetermined amount of time;
transmitting, to a user computer associated with the first authentication token in response to reaching the first time marker, a first alert indicating that the first authentication token is set to expire;
determining, after transmitting the first alert, that the first authentication token has reached a second time marker, the second time marker indicating that the first authentication token will expire in a second predetermined amount of time that is less than the first predetermined amount of time;
transmitting, to the user computer in response to reaching the second time marker, a second alert indicating that the first authentication token is set to expire, a property in the second alert being changed from that in the first alert; and
generating a second authentication token in response to a request to generate a new authentication token, to replace the first authentication token, and then persisting the second authentication token in a database of the management computer.

17. The non-transitory, computer-readable medium of claim 16, wherein the method further comprises:
determining, based on the first time marker, a first transmission mechanism for transmitting the first alert to the user computer;
determining, based on the second time marker, a second transmission mechanism for transmitting the second alert to the user computer, the second transmission mechanism being different from the first transmission mechanism, and the first and second transmission mechanisms each being one of: sending a user interface (UI) message to an application executing on the user computer, sending an email to an email address associated with a user of the user computer, sending a push notification to a push notification service associated with the user computer, and sending a text message to a phone number associated with the user; and
transmitting the first alert to the user computer using the first transmission mechanism, and transmitting the second alert to the user computer using the second transmission mechanism.

18. The non-transitory, computer-readable medium of claim 16, wherein the method further comprises:
transmitting the second authentication token to a third-party server and then receiving an application programming interface (API) request from the third-party server;
extracting the second authentication token from a header of the API request, and validating the extracted second authentication token; and
processing the API request in response to validating the extracted second authentication token.

19. The non-transitory, computer-readable medium of claim 18, wherein the method further comprises:
executing a requested operation or retrieving requested data; and
transmitting a response to the third-party server based on executing the requested operation or based on retrieving the requested data.

20. The non-transitory, computer-readable medium of claim 16, wherein the method further comprises:
transmitting the second authentication token to the user computer and then receiving an application programming interface (API) request from the user computer;
extracting the second authentication token from a header of the API request, and validating the extracted second authentication token; and
processing the API request in response to validating the extracted second authentication token.
